(19) United States
(12) Patent Application Publication
(10) Pub. No.: US 2007/0067304 A1
(43) Pub. Date: Mar. 22, 2007

(54) Search using changes in prevalence of content items on the web

(76) Inventor: Stephen Ives, Cambridgeshire (GB)

Correspondence Address: BARNES & THORNBURG LLP, P.O. BOX 2786, CHICAGO, IL, 60690-2786, US

(21) Appl. No.: 11/248,073

(22) Filed: Oct. 11, 2005

(30) Foreign Application Priority Data
Sep. 21, 2005 (GB) GB0519256.2

(51) Int. Cl. G06F 17/30

(52) U.S. Cl. 707/10

(57) ABSTRACT

A search engine has a query server (50) arranged to receive a search query from a user and return search results, the query server being arranged to identify one or more of the content items relevant to the query, to access a record of changes over time of occurrences of the identified content items, and rank the search results according to the record of changes. This can help find those content items which are currently active, and to track or compare the popularity of content items. This is particularly useful for content items whose subjective value to the user depends on them being topical or fashionable. A content analyzer (100) creates a fingerprint database of fingerprints, to compare the fingerprints to determine a number of occurrences of a given content item at a given time, and to record the changes over time of the occurrences.

### RELATED APPLICATIONS

This application relates to earlier U.S. patent application Ser. No. 11/189,312 filed 26 Jul. 2005, entitled “processing and sending search results over a wireless network to a mobile device” and Ser. No. 11/232,591, filed Sep. 22, 2005, entitled “Systems and methods for managing the display of sponsored links together with search results in a search engine system” claiming priority from UK patent application no. GB0519256.2 of Sep. 21, 2005, the contents of which applications are hereby incorporated by reference in their entirety.

### FIELD OF THE INVENTION

This invention relates to search engines, to content analyzers for such engines, to databases of fingerprints of content items, to methods of using such search engines, to methods of creating such databases, and to corresponding programs.

### DESCRIPTION OF THE RELATED ART

Search engines are known for retrieving a list of addresses of documents on the Web relevant to a search keyword or keywords. A search engine is typically a remotely accessible software program which indexes Internet addresses (universal resource locators (“URLs”), usenet, file transfer protocols (“FTPs”), image locations, etc). The list of addresses is typically a list of “hyperlinks” or Internet addresses of information from an index in response to a query. A user query may include a keyword, a list of keywords or a structured query expression, such as boolean query.

A typical search engine “crawls” the Web by performing a search of the connected computers that store the information and makes a copy of the information in a “web mirror”. This has an index of the keywords in the documents. As any one keyword in the index may be present in hundreds of documents, the index will have for each keyword a list of pointers to these documents, and some way of ranking them by relevance. The documents are ranked by various measures referred to as relevance, usefulness, or value measures. A metasearch engine accepts a search query, sends the query (possibly transformed) to one or more regular search engines, and collects and processes the responses from the regular search engines in order to present a list of documents to the user.

It is known to rank hypertext pages based on intrinsic and extrinsic ranks of the pages based on content and connectivity analysis. Connectivity here means hypertext links to the given page from other pages, called “backlinks” or “inbound links”. These can be weighted by quantity and quality, such as the popularity of the pages having these links. PageRank(™) is a static ranking of web pages used as the core of the Google(™) search engine (http://www.google.com).

As is acknowledged in U.S. Pat. No. 6,751,612 (Schuetze), because of the vast amount of distributed information currently being added daily to the Web, maintaining an up-to-date index of information in a search engine is extremely difficult. Sometimes the most recent information is the most valuable, but is often not indexed in the search engine. Also, search engines do not typically use a user's personal search information in updating the search engine index. Schuetze proposes selectively searching the Web for relevant current information based on user personal search information (or filtering profiles) so that relevant information that has been added recently will more likely be discovered. A user provides personal search information such as a query and how often a search is performed to a filtering program. The filtering program invokes a Web crawler to search selected or ranked servers on the Web based on a user selected search strategy or ranking selection. The filtering program directs the Web crawler to search a predetermined number of ranked servers based on: (1) the likelihood that the server has relevant content in comparison to the user query (“content ranking selection”); (2) the likelihood that the server has content which is altered often (“frequency ranking selection”); or (3) a combination of these.

According to US patent application 2004044962 (Green), current search engine systems fail to return current content for two reasons. The first problem is the slow scan rate at which search engines currently look for new and changed information on a network. The best conventional crawlers visit most web pages only about once a month. To reach high network scan rates on the order of a day costs too much for the bandwidth flowing to a small number of locations on the network. The second problem is that current search engines do not incorporate new content into their “rankings” very well. Because new content inherently does not have many links to it, it will not be ranked very high under Google's PageRank(™) scheme or similar schemes. Green proposes deploying a metacomputer to gather information freshly available on the network, the metacomputer comprises information-gathering crawlers instructed to filter old or unchanged information. To rate the importance or relevance of this fresh information, the page having new content is partially ranked on the authoritativeness of its neighboring pages. As time passes since the new information was found, its ranking is reduced.

As is discussed in U.S. Pat. No. 6,658,423 (Pugh), duplicate or near-duplicate documents are a problem for search engines and it is desirable to eliminate them to (i) reduce storage requirements (e.g., for the index and data structures derived from the index), and (ii) reduce resources needed to process indexes, queries, etc. Pugh proposes generating fingerprints for each document by (i) extracting parts (e.g., words) from the documents, (ii) hashing each of the extracted parts to determine which of a predetermined number of lists is to be populated with a given part, and (iii) for each of the lists, generating a fingerprint. Duplicates can be eliminated, or clusters of near-duplicate documents can be formed, in which a transitive property is assumed. Each document may have an identifier for identifying a cluster with which it is associated. In this alternative, in response to a search query, if two candidate result documents belong to the same cluster and if the two candidate result documents match the query equally well, only the one deemed more likely to be relevant (e.g., by virtue of a high Page rank, being more recent, etc.) is returned. During a crawling operation to speed up the crawling and to save bandwidth near-duplicate Web pages or sites are detected and not crawled, as determined from documents uncovered in a previous crawl. After the crawl, if duplicates are found, then only one is indexed. In response to a query, duplicates can be detected and prevented from being included in search results, or they can be used to “fix” broken links where a document (e.g., a Web page) doesn't exist (at a particular location or URL) anymore, by providing a link to the near-duplicate page.

### SUMMARY OF THE INVENTION

An object of the invention is to provide improved apparatus or methods. According to a first aspect, the invention provides:

A search engine for searching content items accessible online, the search engine having a query server arranged to receive a search query from a user and return search results relevant to the search query, the query server being arranged to identify one or more of the content items relevant to the query, to access a record of changes over time of occurrences of the identified content items, and to rank search results or derive in any other way the search results according to the record of changes over time.

This can help enable a user to find those content items which are currently active, and to track or compare the popularity of content items. This is particularly useful for content items whose subjective value to the user depends on them being topical or fashionable. Compared to existing search engines relying only on quantity and quality of backlinks to rank search results, this aspect of the invention can identify sooner and more efficiently which content items are on an upward trend of prevalence and thus by implication are more popular or more interesting. Also, it can downgrade those which are on a downward trend for example. Thus the search results can be made more relevant to the user.

An additional feature of some embodiments is: the search engine having a content analyzer arranged to create a fingerprint for each content item, maintain a fingerprint database of the fingerprints, to compare the fingerprints to determine a number of occurrences of a given content item at a given time, and to record the changes over time of the occurrences.

Such fingerprints can enable comparisons of a range of media types including audio and visual items. This is particularly useful for the wide range of types and the open ended and uncontrolled nature of the web.

An additional feature of some embodiments is: the occurrences comprising duplicates of the content item at different web page locations. This is useful for content which may be copied easily by users, such as images and audio items. This is based on a recognition that multiple occurrences (duplicates), previously regarded as a problem for search engines, can actually be exploited as a source of useful information for a variety of purposes.

An additional feature of some embodiments is: the occurrences additionally comprising references to a given content item, the references comprising any one or more of: hyperlinks to the given content item, hyperlinks to a web page containing the given item, and other types of references. This is useful for content which is too large to copy readily, such as video items, or interactive items such as games for example.

An additional feature of some embodiments is the search engine being arranged to determine a value representing occurrence from a weighted combination of duplicates, hyperlinks and other types of references. The weighting can help enable a more realistic value to be obtained.

An additional feature of some embodiments is: The search engine being arranged to weight the duplicates, hyperlinks and other types of references according to any one or more of: their type, their location, to favour occurrences in locations which have been associated with more activity and other parameters.

An additional feature of some embodiments is: an index to a database of the content items, the query server being arranged to use the index to select a number of candidate content items, then rank the candidate content items according to the record of changes over time of occurrences of the candidate content items. This enables the computationally-intensive ranking operation to be carried out on a more limited number of items.

An additional feature of some embodiments is: a prevalence ranking server to carry out the ranking of the candidate content items, according to any one or more of: a number of occurrences, a number of occurrences within a given range of dates, a rate of change of the occurrences over time (henceforth called prevalence growth rate), a rate of change of prevalence growth rate (henceforth called prevalence acceleration), and a quality metric of the website associated with the occurrence. This can help enable more relevant results to be found, or provide richer information about the prevalence of a given item for example.

An additional feature of some embodiments is: the content analyzer being arranged to create the fingerprint according to a media type of the content item, and to compare it to existing fingerprints of content items of the same media type. This can make the comparison more effective and enable better search of multi media pages.

An additional feature of some embodiments is: the content analyzer being arranged to create the fingerprint in any manner, for example so as to comprise, for a hypertext content item, a distinctive combination of any of: filesize, CRC (cyclic redundancy check), timestamp, keywords, titles, the fingerprint comprising for a sound or image or video content item, a distinctive combination of any of: image/frame dimensions, length in time, CRC (cyclic redundancy check) over part or all of data, embedded meta data, a header field of an image or video, a media type, or MIME-type, a thumbnail image, a sound signature.

An additional feature of some embodiments is: a web collections server arranged to determine which websites on the world wide web to revisit and at what frequency, to provide content items to the content analyzer. The web collections server can be arranged to determine selections of websites according to any one or more of: media type of the content items, subject category of the content items and the record of changes of occurrences of content items associated with the websites. This can help enable the prevalence metrics to be kept current more efficiently.

The search results can comprise a list of content items, and an indication of rank of the listed content items in terms of the change over time of their occurrences. This can help enable the search to return more relevant results.

Another aspect of the invention provides a content analyzer of a search engine, arranged to create a record of changes over time of occurrences of online accessible content items, the content analyzer having a fingerprint generator arranged to create a fingerprint of each content item, and compare the fingerprints to determine multiple occurrences of the same content item, the content analyzer being arranged to store the fingerprints in a fingerprint database and maintain a record of changes over time of the occurrences of at least some of the content items, for use in responding to search queries.

An additional feature of some embodiments is: The content analyzer being arranged to identify a media type of each content item, and the fingerprint generator being arranged to carry out the fingerprint creation and comparison according to the media type.

An additional feature of some embodiments is: a reference processor arranged to find in a page references to other content items, and to add a record of the references to the record of occurrences of the content item referred to.

An additional feature of some embodiments is: the fingerprint generator being arranged to create the fingerprint to comprise, for a hypertext content item, a distinctive combination of any of: filesize, CRC (cyclic redundancy check), timestamp, keywords, titles, the fingerprint comprising for a sound or image or video content item, a distinctive combination of any of: image/frame dimensions, length in time, CRC (cyclic redundancy check) over part or all of data, embedded meta data, a header field of an image or video, a media type, or MIME-type, a thumbnail image, a sound signature, or any other type of signature.

Another aspect provides a fingerprint database created by the content analyzer and having the fingerprints of content items.

An additional feature of some embodiments is: the fingerprint database having a record of changes over time of occurrences of the content items

Another aspect provides a method of using a search engine having a record of changes over time of occurrences of a given online accessible content item, the method having the steps of sending a query to the search engine and receiving from the search engine search results relevant to the search query, the search results being ranked using the record of changes over time of occurrences of the content items relevant to the query. These are the steps taken at the user's end, which reflect that the user can benefit from more relevant search results or richer information about prevalence changes for example.

An additional feature of some embodiments is: the search results comprising a list of content items, and an indication of rank of the listed content items in terms of the change over time of their occurrences.

Another aspect provides a program on a machine readable medium arranged to carry out a method of searching content items accessible online, the method having the steps of receiving a search query, identifying one or more of the content items relevant to the query, accessing a record of changes over time of occurrences of the identified content items, and returning search results according to the record of changes.

An additional feature of some embodiments is: the program being arranged to use the search results for any one or more of: measuring prevalence of a copyright work, measuring prevalence of an advertisement, focusing a web collection of websites for a crawler to crawl according to which websites have more changes in occurrences of content items, focusing a content analyzer to update parts of a fingerprint database from websites having more changes in occurrences of content items, extrapolating from the record of changes in occurrences for a given content item to estimate a future level of prevalence, pricing advertising according to a rate of change of occurrences, pricing downloads of content items according to a rate of change of occurrences.

Any of the additional features can be combined together and combined with any of the aspects. Other advantages will be apparent to those skilled in the art, especially over other prior art. Numerous variations and modifications can be made without departing from the claims of the present invention. Therefore, it should be clearly understood that the form of the present invention is illustrative only and is not intended to limit the scope of the present invention.

### BRIEF DESCRIPTION OF THE DRAWINGS

How the present invention may be put into effect will now be described by way of example with reference to the appended drawings, in which:

FIG. 1 shows a topology of a search engine according to an embodiment,

FIG. 2 shows an overall process view according to an embodiment,

FIG. 3 shows a content analyzer process according to an embodiment,

FIG. 4 shows a query server process according to an embodiment,

FIG. 5 shows a query server process according to another embodiment,

FIG. 6 shows a content analyzer according to another embodiment,

FIG. 7 shows a web collections database according to another embodiment,

FIG. 8 shows a sample of a fingerprint database according to another embodiment,

FIG. 9 shows a sample of an keyword database, and

FIG. 10 shows a content analyzer according to another embodiment.

### DESCRIPTION OF THE PREFERRED EMBODIMENTS

Definitions

A content item can include a web page, an extract of text, a news item, an image, a sound or video clip, an interactive game or many other types of content for example. Items which are “accessible online” is defined to encompass at least items in pages on websites of the world wide web, items in the deep web (e.g. databases of items accessible by queries through a web page), items available internal company intranets, or any online database including online vendors and marketplaces.

The term “references” in the context of references to content items is defined to encompass at least hyperlinks, thumbnail images, summaries, reviews, extracts, samples, translations, and derivatives.

Changes in occurrence can mean changes in numbers of occurrences and/or changes in quality or character of the occurrences such as a move of location to a more popular or active site.

A “keyword” can encompass a text word or phrase, or any pattern including a sound or image signature.

Hyperlinks are intended to encompass hypertext, buttons, softkeys or menus or navigation bars or any displayed indication or audible prompt which can be selected by a user to present different content.

The term “comprising” is used as an open ended term, not to exclude further items as well as those listed.

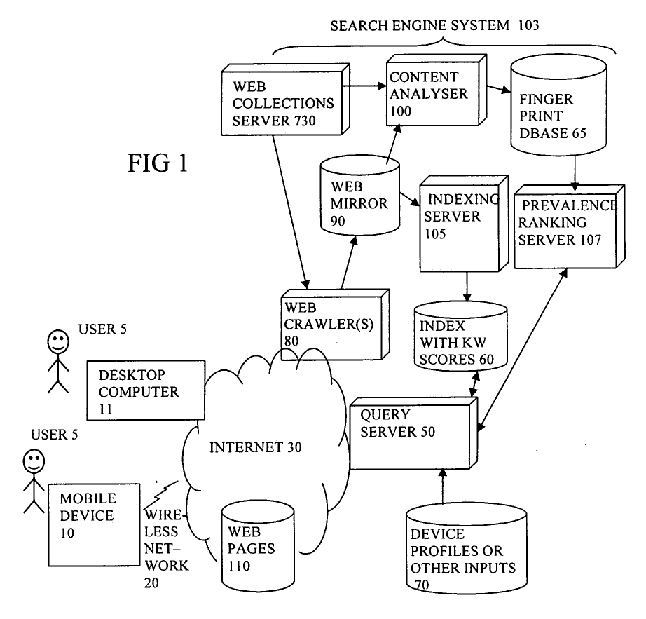

FIG. 1, Overall Topology

The overall topology of a first embodiment of the invention is illustrated in FIG. 1.

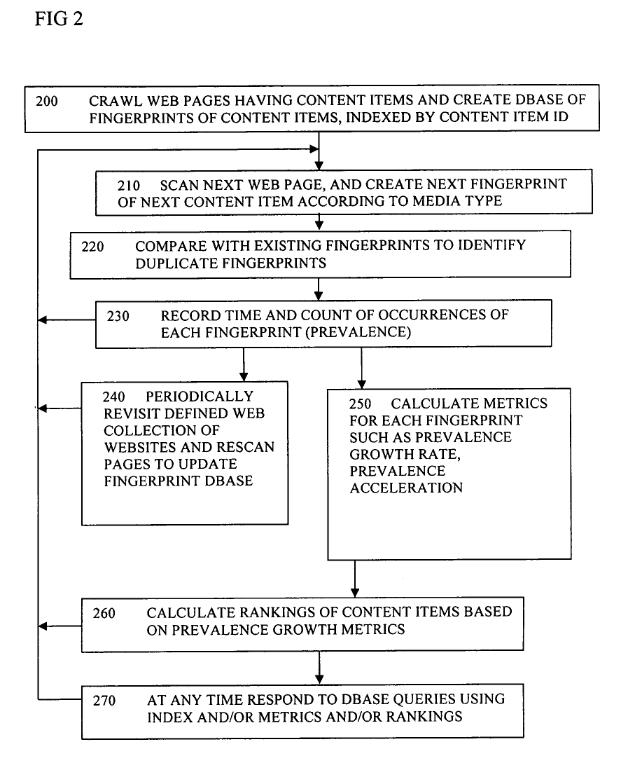

FIG. 2 shows a summary of some of the main processes. In FIG. 1, a query server 50 and web crawler 80 are connected to the Internet 30 (and implemented as Web servers—for the purposes of this diagram the web servers are integral to the query and web crawler servers). The web crawler spiders the World Wide Web to access web pages 110 and builds up a web mirror database 90 of locally-cached web pages. The crawler is directed by a web collections server 730 which controls which websites are revisited and how often, so that changes in occurrences of content items can be detected by the content analyzer. An index server 105 builds an index 60 of the web pages from this web mirror. The content analyzer 100 processes the web pages and associated multimedia files accumulated in the web mirror, and derives fingerprint information from each of these multimedia files. This fingerprint information is captured within a fingerprint database 65. Also shown in FIG. 1 is a prevalence ranking server 107 which can calculate rankings and other prevalence based metrics from the fingerprint database. These parts form a search engine system 103. This system can be formed of many servers and databases distributed across a network, or in principle they can be consolidated at a single location or machine. The term search engine can refer to the front end, which is the query server in this case, and some, all or none of the back end parts used by the query server.

A plurality of users 5 connected to the Internet via desktop computers 11 or mobile devices 10 can make searches via the query server. The users making searches (‘mobile users’) on mobile devices are connected to a wireless network 20 managed by a network operator, which is in turn connected to the Internet via a WAP gateway, IP router or other similar device (not shown explicitly).

Many variations are envisaged, for example the content items can be elsewhere than the world wide web, the content analyzer could take content from its source rather than the web mirror and so on.

Description of Devices

The user can access the search engine from any kind of computing device, including desktop, laptop and hand held computers. Mobile users can use mobile devices such as phone-like handsets communicating over a wireless network, or any kind of wirelessly-connected mobile devices including PDAs, notepads, point-of-sale terminals, laptops etc. Each device typically comprises one or more CPUs, memory, I/O devices such as keypad, keyboard, microphone, touchscreen, a display and a wireless network radio interface.

These devices can typically run web browsers or microbrowser applications e.g. Openwave™, Access™, Opera™ browsers, which can access web pages across the Internet. These may be normal HTML web pages, or they may be pages formatted specifically for mobile devices using various subsets and variants of HTML, including cHTML, DHTML, XHTML, XHTML Basic and XHTML Mobile Profile. The browsers allow the users to click on hyperlinks within web pages which contain URLs (uniform resource locators) which direct the browser to retrieve a new web page.

Description of Servers

There are four main types of server that are envisaged in one embodiment of the search engine according to the invention as shown in FIG. 1, as follows. Although illustrated as separate servers, the same functions can be arranged or divided in different ways to run on different numbers of servers or as different numbers of processes, or be run by different organisations.
a) A query server that handles search queries from desktop PCs and mobile devices, passing them onto the other servers, and formats response data into web pages customised to different types of devices, as appropriate. Optionally the query server can operate behind a front end to a search engine of another organization at a remote location. Optionally the query server can carry out ranking of search results based on prevalence growth metrics, or this can be carried out by a separate prevalence ranking server.
b) A web collections server that directs a web crawler or crawlers to traverse the World Wide Web, loading web pages as it goes into a web mirror database, which is used for later indexing and analyzing. The web collections server controls which websites are revisited and how often, to enable changes in occurrences to be detected. This server maintains web collections which are lists of URLs of pages or websites to be crawled. The crawlers are well known devices or software and so need not be described here in more detail
c) An index server that builds a searchable index of all the web pages in the web mirror, stored in the index, this index containing relevancy ranking information to allow users to be sent relevancy-ranked lists of search results. This is usually indexed by ID of the content and by keywords contained in the content.
d) A content analyzer server that reads the multimedia files collected on the web mirror, sorts them by category, and for each category derives a characteristic fingerprint (see below for details of this process) which acts as a fingerprint for this file. These fingerprints are saved into a database which is stored together with the index written by the index server. This server can also act as the reference processor arranged to find in a page references to other content items, and to add a record of the references to the record of occurrences of the content item referred to.

Web server programs are integral to the query server and the web crawler servers. These can be implemented to run Apache™ or some similar program, handling multiple simultaneous HTTP and FTP communication protocol sessions with users connecting over the Internet. The query server is connected to a database that stores detailed device profile information on mobile devices and desktop devices, including information on the device screen size, device capabilities and in particular the capabilities of the browser or microbrowser running on that device. The database may also store individual user profile information, so that the service can be personalised to individual user needs. This may or may not include usage history information.

The search engine system comprises the web crawler, the content analyzer, the index server and the query server. It takes as its input a search query request from a user, and returns as an output a prioritised list of search results. Relevancy rankings for these search results are calculated by the search engine by a number of alternative techniques as will be described in more detail.

It is the prevalence growth rate and prevalence acceleration measures that are primarily used to calculate relevance, optionally in conjunction with other methods. Such changes in prevalence can indicate the content is currently particularly popular, or particularly topical, which can help the search engine improve relevancy or improve efficiency. Certain kinds of content e.g. web pages can be ranked by existing techniques already known in the art, and multimedia content e.g. images, audio, can be ranked by prevalence change. The type of ranking can be user selectable. For example users can be offered a choice of searching by conventional citation-based measures e.g. Google's™ PageRank™ or by other prevalence-related measures.

Description of Process, FIGS. 2, 3, 4

FIG. 2 shows an overview of the various processes in the form of a flow chart. At step 200 web pages are crawled and the web pages are scanned or parsed to detect content items and create fingerprints of each item. These are stored in the fingerprint database, indexed by content item ID. At step 210, a next web page is scanned, fingerprints created and at step 220 compared to existing fingerprints of the same media type to identify duplicate occurrences. At step 230 the time and count of the duplicates is recorded (prevalence metrics). At step 240, periodically a defined web collection of websites is revisited and pages rescanned to update the fingerprint database and thus the prevalence. At step 250, prevalence metrics are calculated, such as rate of change of occurrences. At step 260 rankings of content items are calculated based on prevalence change metrics. The process repeats for next web pages, or at any time at step 270, the query server responds to dbase queries using the index and/or metrics and/or rankings.

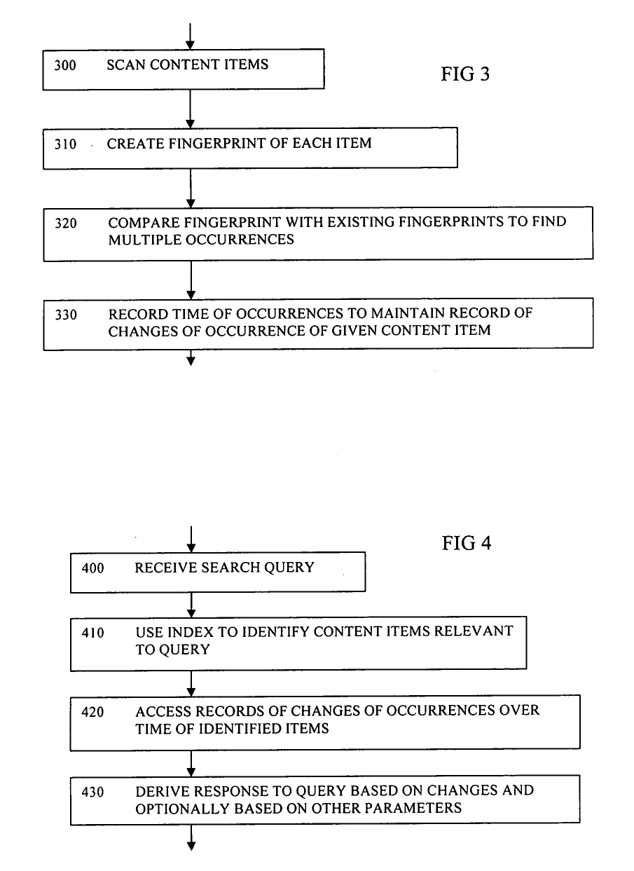

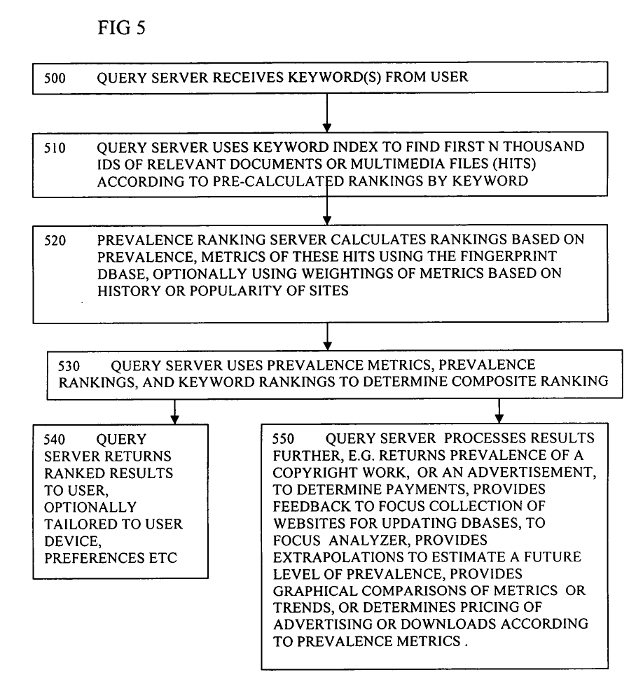

FIGS. 3 and 4 show a summary of steps carried out by the content analyzer and the query server processes respectively. At step 300, the content analyzer scans content items, usually from the web mirror. At 310 a fingerprint is created. At 320 the fingerprint is compared to find duplicate occurrences. At 330 the server records the time of occurrence and maintains a record of changes in occurrences of the given content item.

FIG. 4 shows the principle steps of the query server process. A query is received at step 400. At 410 the index is used to find content items relevant to the query. At 420 the records of changes in occurrence are accessed for the given items. At 430, the process determines a response to the query based on the changes and optionally on other parameters.

Query Server, FIG. 5

Another embodiment of a query server operation is shown in FIG. 5. In this example, a keyword or words is received from a user at step 500. At step 510, the query server uses an index to find the first n thousand IDs of relevant content items in the form of documents or multimedia files (hits) according to pre-calculated rankings by keyword. At step 520, a fingerprint metrics server calculates prevalence growth, prevalence growth rate, and prevalence growth acceleration, and uses these to calculate rankings of these hits using the fingerprint dbase, optionally using weightings of metrics based on history or popularity of sites. At step 530, the query server uses prevalence metrics, prevalence rankings, and keyword rankings to determine a composite ranking. The query server returns ranked results to user, optionally tailored to user device, preferences etc at step 540. Alternatively, at step 550, the query server processes the results further, e.g. returns prevalence of a copyright work, or an advertisement, to determine payments, provides feedback to focus web collections of websites for updating dbases, to focus a content analyzer, provides extrapolations to estimate a future level of prevalence, provides graphical comparisons of metrics or trends, or determines pricing of advertising or downloads according to prevalence metrics. Other ways of using the prevalence metrics can be envisaged.

The query server can be arranged to enable more advanced searches than keyword searches, to narrow the search by dates, by geographical location, by media type and so on. Also, the query server can present the results in graphical form to show prevalence growth profiles for one or more content items. The query server can be arranged to extrapolate from results to predict for a example a peak prevalence of a given content item. Another option can be to present indications of the confidence of the results, such as how frequently relevant websites have been revisited and how long since the last occurrence was found, or other statistical parameters.

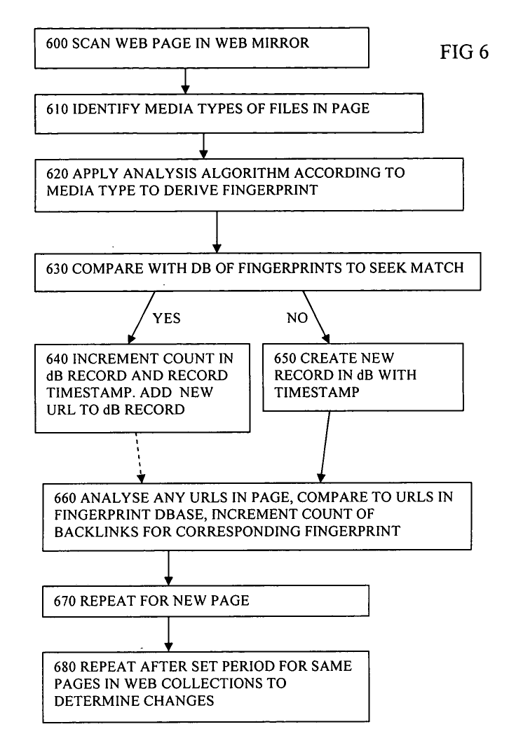

Content Analyzer, FIG. 6

Another embodiment of a content analyzer operation is shown in FIG. 6. In this case, at step 600, a web page is scanned from the web mirror. At step 610 media types of files in the pages are identified. At step 620 an analysis algorithm is applied to each file according to the media type of the file, to derive its fingerprint. At step 630, this fingerprint is compared to others in the fingerprint database to seek a match. If a match is found, at step 640 the process increments the count of occurrences in the database record and records a timestamp, and optionally adds the new URL to the record, so that the new occurrence can be weighted by location, or so that there is a backup URL. At step 650 if there is no match, it creates a new record in the database with a timestamp. At step 660, any URLs in the page are analysed and compared to URLs of fingerprints in the fingerprint database or elsewhere. If a match is found, the process increments the count of backlinks for the corresponding fingerprint pointed to by the URL. The same can be done for other types of references such as text references to an author or to a title for example. The process is repeated for a next page at step 670, and after a set period, the pages in a given web collection are rescanned to determine their changes, and keep the prevalence change metrics up to date, at least for that web collection. The web collections are selected to be representative.

A more detailed discussion of some of the various process steps now follows. Embodiments may have any combination of the various features discussed, to suit the application.

Step 1: determine a web collection of web sites to be monitored. This web collection should be large enough to provide a representative sample of sites containing the category of content to be monitored, yet small enough to be revisited on regular and frequent (e.g. daily) basis by a set of web crawlers.

Step 2: set web crawlers running against these sites, and create web mirror containing pages within all these sites.

Step 3: During each time period, scan files in web mirror, for each given web page identify file categories (e.g. audio midi, audio MP3, image JPG, image PNG) which are referenced within this page.

Step 4: For each category, apply the appropriate analyzer algorithm which reads the file, and looks for unique fingerprint information. This can be carried out by any type of fingerprinting (see some examples below)

Step 5: During each time period, and for each web page and file found in that web page, compare this identifier information with the database of fingerprints which already exist. Decide whether the fingerprint matches an existing fingerprint (either an exact match or a match within the bounds of statistical probability e.g. 99% certainty that the content items are identical)

Step 6a: If the fingerprint doesn't match any fingerprint in the database, create a new fingerprint instance and link it to the web page URL from which it came, with a time stamp, as a new database record. Information to be contained in this database record:

Multimedia content category: (e.g. audio)

Multimedia file type: (e.g. MP3)

File fingerprint: (usually a computed binary or ASCII sequence)

Web mirror URL:

Web page source URL:

Time web page saved into mirror:

Time that file was identified (fingerprinted):

Step 6b: If the fingerprint does match an existing fingerprint in the database, increment the count for this identifier by 1, and record in the database the new URL information associated with this file and the time information (time web page saved into mirror, time that file was identified).

Step 7: Over time, for the given web collection of web sites and pages that are periodically searched, build up a complete inventory of the number of occurrences of each fingerprint. The occurrence value can be weighted to favour occurrences at highly active sites for example. This can be determined from counts of backlinks, or from other metrics including sites which originate fast-growing content items, in which case the prevalence ranking server can feedback information to adjust the weights. Also, the occurrence value can take into account more than duplicates. The occurrence value (O) can be calculated from a weighted total of Duplicates, Backlinks and References, where:
Duplicates (=D) are duplicate copies of the content item at a different web page location as evaluated by matching of their respective fingerprints, including near matches.
Backlinks (=B) can comprise hypertext links to the content item or to a web page referencing or containing the specific content item, from other web pages.
References (=R) can comprise one or more of: an extract, a summary, a review, a translation, a thumbnail image, an adaptation of the content item, or any other type of reference (assuming the reference contains enough information from or associated with the original item to be able to deduce a relationship with the original)
   O=D+×(expB×C1)+y(expR×C2)
   Where: x, y, C1 and C2 are constants, and expB and expR are exponential functions of B and R.

This algorithm is an example only, and many other such algorithms can be envisaged. In practice the algorithm can be changed regularly to counter commercial users trying to artificially influence their rankings.

Step 8: Compare totals for each fingerprint with totals from previous time periods. From the changes between occurrences in time periods, calculate appropriate measures (e.g. velocity, acceleration) and write these values into the index against the corresponding fingerprints. These values are used to calculate relevancy rankings which are also written into the index.

Step 9: When a search query is received, with keyword or combination of keywords, and associated with a specific content category (e.g. audio) the keyword(s) is used as a search term into the index, which then returns a list of web pages which contain matching multimedia content files, these pages ranked by the selected change in occurrence measure of the multimedia file that they contain (e.g. velocity, acceleration).

Step 10: The user selects the result web page (or optionally, an extracted object) from the results list, and is able to view or play the multimedia object of high calculated ranking that is referenced within this page.

The fingerprint can be any type of fingerprint, examples can include a distinctive combination of any of the following aspects of a content item (usually, but not restricted to, metadata)

size

image/frame dimensions

length in time

CRC (cyclic redundancy check) over part or all of data

Embedded meta data, eg: header fields of images, videos etc

Media type, or MIME-type

Currently it is computationally expensive to carry out large-scale processing and analysis of all of the contents of all types of multimedia file. However there are techniques to reduce this burden. For music files, it is already practical to analyse content information near the beginning of the file and process it to extract a fingerprint in the form of a unique signature or identifier. Midi files can be processed in this way: they are small and they contain inherently digital rather than analog information. There are some systems which can already identify music files with a high degree of accuracy (Shazam™, Snocap™). Corresponding signatures can be envisaged for video files and other file types.

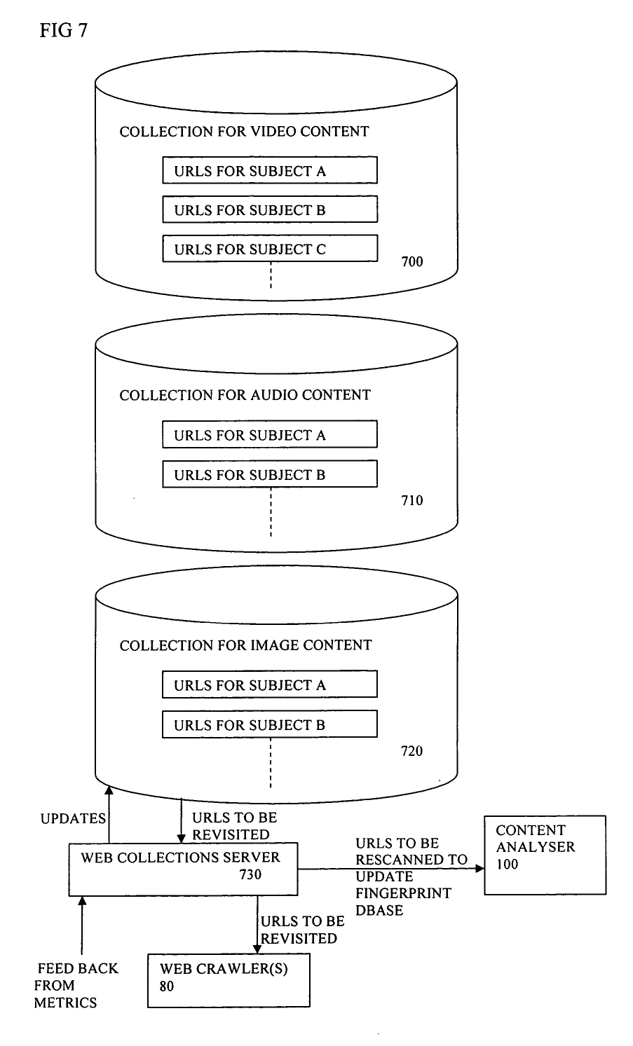

Web Collections, FIG. 7

FIG. 7 shows an example of a database of web collections. Three web collections are shown, there could be many more. Web collection 700 is for video content and has lists or URLs of pages or preferably websites according to subject, in other words different categories of content, for example sport, pop music, shops and so on. Web collection 710 is for audio content, and likewise has lists of URLs for different subjects. Web collection 720 is for image content and again has lists of URLs for different subjects. The web collections are for use where there are so many content items that it is impractical to revisit all of them to update the prevalence metrics. Hence the web collections are a representative selection of popular or active websites which can be revisited more frequently, but large enough to enable changes in prevalence, or at least relative changes in prevalence to be monitored accurately.

A web collections server 730 is provided to maintain the web collections to keep them representative, and to control the timing of the revisiting. For different media types or categories of subject, there may be differing requirements for frequency of update, or of size of web collection. The frequency of revisiting can be adapted according to prevalence growth rate and prevalence acceleration metrics generated by the prevalence ranking server. For example, the revisit frequency could be automatically adjusted upwards for web sites associated with relatively high prevalence growth rate and prevalence growth acceleration numbers, and downwards for sites having relatively low numbers. Such adaptation could also be on the basis of which websites rank highly by keyword or backlink rankings. The updates may be made manually. To control the revisiting, the web collections server feeds a stream of URLs to the web crawlers, and can be used to alert the content analyser as to which pages have been updated in the mirror and should be rescanned for changes in content items. The content analyser can be arranged to carry out a preliminary operation to find if a web page is unchanged from the last scan, before it carries out the full fingerprinting process for all the files in the page.

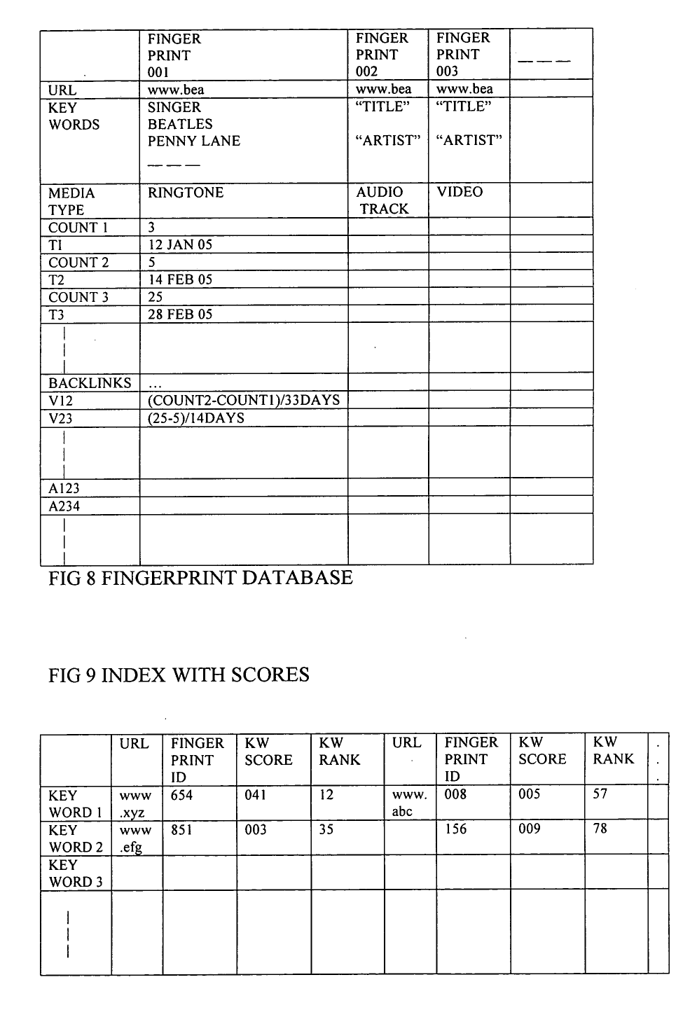

Databases, FIGS. 8, 9

FIG. 8 shows an example of an extract of a fingerprint database showing a record in each column. Three are shown, in practice there can be literally millions. For each fingerprint there is a record having the fingerprint value, then the primary or originating URL, a list of keywords (e.g. SINGER, BEATLES, PENNY LANE), a media type (e.g. RINGTONE), then a series of occurrence values (Count1, Count 2 . . . ) at different dates (T1, T2 . . . ). The occurrence values can be simple counts or more complex values formed from combinations of weighted counts and weighted numbers of references to the content item as discussed above. The record can also include other calculated metrics such as prevalence velocity v12 over a given period (T1 to T2) (for example (count2−count1)/33 DAYS), and prevalence acceleration A123 over a given period (T1 to T3). Many other metrics can be envisaged according to the application. References to a fingerprint can include its associated meta-data such as its media type, URL, address in the fingerprint database and so on.

FIG. 9 shows an example of an index with scores, and showing a number of columns for a series of content items (in this case identified by a URL pointing to the original content, or to its copy in the web mirror). For a given row, all the content items which have the given keyword, will have a record. The record in this case has four parts (more could be used), set out in four columns. First is shown the URL of the page having the content item. A next column has the finger print ID in the form of a pointer to the record of the fingerprint in the fingerprint database). A third column for each record has a keyword score for that keyword in the given document. A fourth column shows a keyword rank of the score relative to other scores for the same keyword. Eight columns are shown, representing the first two content items for each keyword, but again there can be millions in practice. One purpose of this index is to enable the query server to obtain easily the top scoring content items for a given keyword, to make a list of candidate content items which can then be ranked according to prevalence metrics by the ranking server.

An indexing server will create this index and keep adding to it as new content items are crawled and fingerprinted, using information from the content analyzer or fingerprint database. Each column has a number of rows for different keywords. The keyword score (e.g. 654) represents a composite score of the relevancy based on for example the number of hits in the content item and an indication of the positions of the keyword in the item. More weight can be given to hits in a URL, title, anchor text, or meta tag, than hits in the main body of a content item for example. Non text items such as audio and image files can be included by looking for hits in metadata, or by looking for a key pattern such as an audio signature or image. The prevalence metrics could in some embodiments be used as an input to this score, as an alternative or as an addition to the subsequent step of ranking the candidates according to prevalence metrics. In the example shown of a keyword score for that document is recorded (e.g. 041).

Adjacent to the score is a keyword rank, for example 12, which in other words means there are currently 11 other items having more relevance for that keyword. Hence a query server can use this index to obtain a list of candidate items (actually their fingerprint IDs) that are most relevant to a given keyword. The ranking server can then rank the selected candidate items.

Any indexing of a large uncontrolled set of content items such as the world wide web typically involves operations of parsing before the indexing, to handle the wide range of inconsistencies and errors in the items. A lexicon of all the possible keywords can be maintained and shared across multiple indexing servers operating in parallel. This lexicon can also be a very large entity of millions of words. The indexing operation also typically involves sorting the results, and generating the ranking values. The indexer can also parses out all the hyperlinks in every web page and store information about them in an anchors file. This can be used to determine where each link points from and to, and the text of the link.

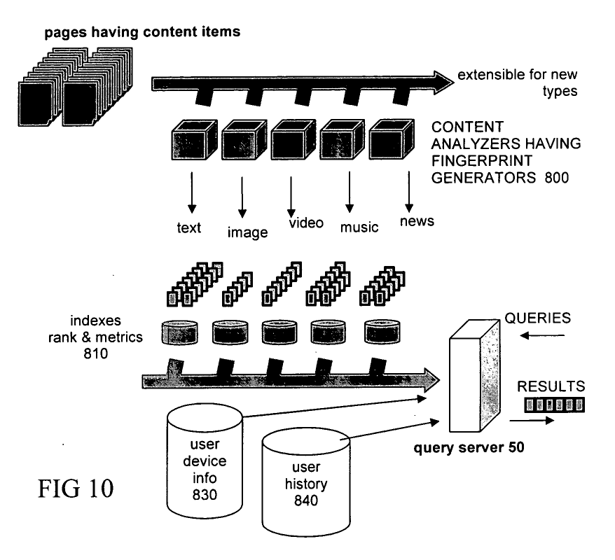

Content Analyzer, FIG. 10

FIG. 10 shows a schematic view of an example of a content analyzer having fingerprint generators for each different media type. The pages having content items are scanned and items of different media types are found and passed to fingerprint generators 800. These processes or servers each create and compare the fingerprints as discussed above, and build the database or databases of fingerprints as described above. The database can have inbuilt or separate stores having indexes of fingerprint IDs pointing into the fingerprint databases, and the records of ranks and metrics. FIG. 10 shows how these records and indexes are accessible to the query server 50. The query server is also arranged to access device info 830 and user history 840.

Other features

In an alternative embodiment, the search is not of the entire web, but of a limited part of the web or a given database.

In another alternative embodiment, the query server also acts as a metasearch engine, commissioning other search engines to contribute results (e.g. Google™, Yahoo™, MSN™) and consolidating the results from more than one source.

In an alternative embodiment, the web mirror is used to derive content summaries of the content items. These can be used to form the search results, to provide more useful results than lists of URLs or keywords. This is particularly useful for large content items such as video files. They can be stored along with the fingerprints, but as they have a different purpose to the keywords, in many cases they will not be the same. A content summary can encompass an aspect of a web page (from the world wide web or intranet or other online database of information for example) that can be distilled/extracted/resolved out of that web page as a discrete unit of useful information.

It is called a summary because it is a truncated, abbreviated version of the original that is understandable to a user.

Example types of content summary include (but are not restricted to) the following:
Web page text—where the content summary would be a contiguous stretch of the important, information-bearing text from a web page, with all graphics and navigation elements removed.
News stories, including web pages and news feeds such as RSS—where the content summary would be a text abstract from the original news item, plus a title, date and news source.
Images—where the content summary would be a small thumbnail representation of the original image, plus metadata such as the file name, creation date and web site where the image was found.
Ringtones—where the content summary would be a starting fragment of the ringtone audio file, plus metadata such as the name of the ringtone, format type, price, creation date and vendor site where the ringtone was found.
Video Clips—where the content summary would be a small collection (e.g. 4) of static images extracted from the video file, arranged as an animated sequence, plus metadata

The Web server can be a PC type computer or other conventional type capable of running any HTTP (Hyper-Text-Transfer-Protocol) compatible server software as is widely available. The Web server has a connection to the Internet 30. These systems can be implemented on a wide variety of hardware and software platforms.

The query server, and servers for indexing, calculating metrics and for crawling or metacrawling can be implemented using standard hardware. The hardware components of any server typically include: a central processing unit (CPU), an Input/Output (I/O) Controller, a system power and clock source; display driver; RAM; ROM; and a hard disk drive. A network interface provides connection to a computer network such as Ethernet, TCP/IP or other popular protocol network interfaces. The functionality may be embodied in software residing in computer-readable media (such as the hard drive, RAM, or ROM). A typical software hierarchy for the system can include a BIOS (Basic Input Output System) which is a set of low level computer hardware instructions, usually stored in ROM, for communications between an operating system, device driver(s) and hardware. Device drivers are hardware specific code used to communicate between the operating system and hardware peripherals. Applications are software applications written typically in C/C++, Java, assembler or equivalent which implement the desired functionality, running on top of and thus dependent on the operating system for interaction with other software code and hardware. The operating system loads after BIOS initializes, and controls and runs the hardware. Examples of operating systems include Linux™, Solaris™, Unix™, OSX™ Windows XP™ and equivalents.

1. A search engine for searching content items accessible online, the search engine having a query server arranged to receive a search query from a user and return search results relevant to the search query, the query server being arranged to identify one or more of the content items relevant to the query, to access a record of changes over time of occurrences of the identified content items, and to derive the search results according to the record of changes.

2. The search engine of claim 1, arranged to rank the search results according to the record of changes.

3. The search engine of claim 2, having a content analyzer arranged to create a fingerprint for each content item, maintain a fingerprint database of the fingerprints, to compare the fingerprints to determine a number of the occurrences of a given content item at a given time, and to create the record of changes over time of the occurrences.

4. The search engine of claim 2, the occurrences comprising duplicates of the content item at different web page locations.

5. The search engine of claim 4, the occurrences additionally comprising references to a given content item, the references comprising any one or more of: hyperlinks to the given content item, hyperlinks to a web page containing the given item, and other types of references.

6. The search engine of claim 5, arranged to determine a value representing occurrence from a weighted combination of duplicates, hyperlinks and other types of references.

7. The search engine of claim 6, arranged to weight the duplicates, hyperlinks and other types of references according to any one or more of: their type, their location, to favour occurrences in locations which have been associated with more activity and other parameters.

8. The search engine of claim 2, the search engine comprising an index to a database of the content items, the query server being arranged to use the index to select a number of candidate content items, then rank the candidate content items according to the record of changes over time of occurrences of the candidate content items.

9. The search engine of claim 8, having a prevalence ranking server to carry out the ranking of the candidate content items, according to any one or more of: a number of occurrences, a number of occurrences within a given range of dates, a rate of change of the occurrences, a rate of change of the rate of change of the occurrences, and a quality metric of the website associated with the occurrence.

10. The search engine of claim 3, the content analyzer being arranged to create the fingerprint according to a media type of the content item, and to compare it to existing fingerprints of content items of the same media type.

11. The search engine of claim 3, the content analyzer being arranged to create the fingerprint to comprise, for a hypertext content item, a distinctive combination of any of: filesize, CRC (cyclic redundancy check), timestamp, keywords, titles, the fingerprint comprising for a sound or image or video content item, a distinctive combination of any of: image/frame dimensions, length in time, CRC (cyclic redundancy check) over part or all of data, embedded meta data, a header field of an image or video, a media type, or MIME-type, a thumbnail image, a sound signature.

12. The search engine of claim 2 having a web collections server arranged to determine which websites on the world wide web to revisit and at what frequency, to provide content items to the content analyzer.

13. The search engine of claim 12, the web collections server being arranged to determine revisits according to any one or more of: media type of the content items, subject category of the content items, and the record of changes of occurrences of content items associated with the websites.

14. The search engine of claim 2 the search results comprising a list of content items, and an indication of rank of the listed content items in terms of the change over time of their occurrences.

15. A content analyzer of a search engine, arranged to create a record of changes over time of occurrences of online accessible content items, the content analyzer having a fingerprint generator arranged to create a fingerprint of each content item, and compare the fingerprints to determine multiple occurrences of the same content item, the content analyzer being arranged to store the fingerprints in a fingerprint database and maintain a record of changes over time of the occurrences of at least some of the content items, for use in responding to search queries.

16. The content analyzer of claim 15 arranged to identify a media type of each content item, and the fingerprint generator being arranged to carry out the fingerprint creation and comparison according to the media type.

17. The content analyzer of claim 15 having a reference processor arranged to find in a page references to other content items, and to add a record of the references to the record of occurrences of the content item referred to.

18. The content analyzer of claim 15, the fingerprint generator being arranged to create the fingerprint to comprise, for a hypertext content item, a distinctive combination of any of: filesize, CRC (cyclic redundancy check), timestamp, keywords, titles, the fingerprint comprising for a sound or image or video content item, a distinctive combination of any of: image/frame dimensions, length in time, CRC (cyclic redundancy check) over part or all of data, embedded meta data, a header field of an image or video, a media type, or MIME-type, a thumbnail image, a sound signature.

19. A fingerprint database created by the content analyzer of claim 15 and storing the fingerprints of content items.

20. The fingerprint database of claim 19 having a record of changes over time of occurrences of the content items

21. A method of using a search engine having a record of changes over time of occurrences of a given online accessible content item, the method having the steps of sending a query to the search engine and receiving from the search engine search results relevant to the search query, the search results being ranked using the record of changes over time of occurrences of the content items relevant to the query.

22. The method of claim 21, the search results comprising a list of content items, and an indication of rank of the listed content items in terms of the change over time of their occurrences.

23. A program on a machine readable medium arranged to carry out a method of searching content items accessible online, the method having the steps of receiving a search query, identifying one or more of the content items relevant to the query, accessing a record of changes over time of occurrences of the identified content items, and returning search results according to the record of changes.

24. The program of claim 23 being arranged to use the search results for any one or more of: measuring prevalence of a copyright work, measuring prevalence of an advertisement, focusing a web collection of websites for a crawler to crawl according to which websites have more changes in occurrences of content items, focusing a content analyzer to update parts of a fingerprint database from websites having more changes in occurrences of content items, extrapolating from the record of changes in occurrences for a given content item to estimate a future level of occurrence, pricing advertising according to a rate of change of occurrences, pricing downloads of content items according to a rate of change of occurrences.
